(19) United States
(12) Patent Application Publication
(10) Pub. No.: US 2009/0300028 A1
(43) Pub. Date: Dec. 3, 2009

(54) DEVICE AND METHOD FOR MANAGING DIGITAL SIGNAGE SYSTEMS

(75) Inventor: Avishay BEN NATAN, Rishon LeZion (IL)

Correspondence Address: BROWDY AND NEIMARK, P.L.L.C.;624 NINTH STREET, NW, SUITE 300, WASHINGTON, DC, 20001-5303, US

(73) Assignee: C-Nario Ltd., Tel-Aviv (IL)

(21) Appl. No.: 12/470,730

(22) Filed: May 22, 2009

(30) Foreign Application Priority Data
May 28, 2008 (IL) 191667

(51) Int. Cl. G06F 17/30

(52) U.S. Cl. 707/10; 707/E17.032

(57) ABSTRACT

A method is provided for managing information during a pre-determined period of time at a plurality of remote display surfaces, based on criteria established at a central terminal, wherein the method comprises: i) providing a pre-determined period of time; ii) providing at least two digital signage objects; iii) determining at least one properties' sub set which comprises a plurality of attributes for each of the digital signage objects provided; iv) determining the value of attributes included in the at least one properties' sub set for the duration of the pre-determined period of time; v) establishing at least one identity group comprising digital signage objects each of which is identical in its properties during the respective pre-determined period of time, to the other digital signage objects belonging to a respective identity group; and vi) applying the at least one identity group for managing information at the plurality of remote channels.

### FIELD OF THE INVENTION

The present invention relates to digital signage systems. Particularly, it concerns methods and devices for managing multiple objects in digital signage systems.

### BACKGROUND OF THE INVENTION

Digital signage systems are used to display information in public places. In most installations, data is sent from one or more different locations and stored on a local player non-volatile storage, such as disk, to be played by a predefined schedule.

One of the difficulties associated with such digital signage systems is the management of multiple channels having diverse states. Since every such system comprises a large number of displays, at which sometimes different contents should be displayed in order to meet the contractual obligations of the system operators, it becomes prohibitively difficult to manage and schedule different content on the diversity of all channels. Other management tasks such as monitoring and control become challenging when a large number of channels is involved. Thus, it is important to provide new methods to overcome management difficulties in large digital signage networks.

### Glossary

The following terms having the following meanings are used throughout the specification and claims in describing the present invention.
Application Module—software entity typically associated with certain digital signage workflow or functionality.
Digital Signage Object—defines an entity (whether remote or local) which has a set of given properties having certain values at a given moment or period of time.
Identical Properties—a group of “Digital Signage Object” may have “identical properties” for a period of time or at a given moment. For example, a group of “Digital Signage Objects” may have the same “explicit playlist” or the same “rule based playlist” if they behave exactly the same in respect of the object's properties for the defined “period of time”, in which case they may be compiled into an identical “explicit playlist”.
Identity Group—all “digital signage objects” having an identical “properties' sub set” for a given period of time will belong to the same identity group for that “period of time”. Objects can belong to different Identity Groups when associated with different “Application Modules” or when a different period of time is selected.
Period of Time—a pair of start and end date and time values, defining a time period.
Properties' Sub Set—a set of properties associated with an object. “Properties' sub sets” are normally associated with one or more “Application Modules
Playlist—a list of “Media Items”.
Explicit Playlist—a collection of media items where each of the “media items sets” has been assigned with a timestamp. In most cases the “explicit playlist” is locally or remotely calculated in accordance with a set of rules.
Rule Based Playlist—a collection of “media items” from which a proceeding set of “media items” is selected in accordance with a pre-defined rules for playback. A trivial example of such a “rule based playlist” is a simple loop of playing items.

### SUMMARY OF THE INVENTION

It is an object of the present invention to provide an improved way of managing the diversity of differently attributed digital signage entities including but not limited to differently scheduled channels.

Other objects of the invention will become apparent as the description of the invention proceeds.

Thus, according with a first embodiment of the present invention there is provided a computer-readable medium comprising instructions that perform a method (process) that when executed by a processor, is operative to establish a process for managing information during a pre-determined period of time at a plurality of remote display surfaces based on criteria established at a central terminal, wherein the method comprises:

at the central terminal (e.g. at the digital signage workstation):

providing a pre-determined period of time;

providing at least two digital signage objects;

determining at least one properties' sub set which comprises a plurality of attributes for each of the digital signage objects provided, where this selection is preferably based upon the current workflow or application module used;

determining the value of attributes included in the at least one ‘properties' sub set’ for the duration of the pre-determined period of time, where the value may be for example a number, a playlist set and the like;

establishing at least one identity group comprised of digital signage objects identical in their properties' sub set (preferably associated with the application module or workflow at hand) to each other during the respective pre-defined period of time; and

using the at least one identity group for managing information at the plurality of remote display surfaces.

The term “managing information” as used herein should be understood to encompass viewing information and/or editing information and/or splitting identity groups and/or merging identity groups.

In accordance with a preferred embodiment of the invention, the method provided further comprises the step of selecting at least one digital signage object from an identity group for which at least one of the attributes is to be modified, and creating a new identity group which comprises all members of the original identity group that should undergo such modification.

By another preferred embodiment of the invention, the method provided further comprising a step of effecting a change at the identity group level, which change shall be carried out directly or indirectly on each of the digital signage objects belonging to that identity group.

According to another embodiment of the invention, the method provided further comprises a step by which an identity group is divided into two new identity groups upon applying at least one change to one of these two new identity groups, wherein one of the newly formed identity groups comprises all the members of the old identity group which are to be affected by the at least one change when applied, and the other new identity group comprises all the remaining members of the old identity group that would not be affected by that at least one change.

By still another preferred embodiment of the invention, the method provided further comprises a step of merging two identity groups by applying attributes' values associated with one group of the digital signage objects to those of the other group.

According to another aspect of the present invention, there is provided a method for managing information during a pre-determined period of time at a plurality of remote display surfaces based on criteria established at a central terminal, wherein the method comprises:

providing a pre-determined period of time;

providing at least two digital signage objects;

determining at least one properties' sub set which comprises a plurality of attributes for each of the digital signage objects provided;

determining the value of attributes included in the at least one properties' sub set for the duration of the pre-determined period of time;

establishing at least one identity group comprising digital signage objects identical in their properties to each other during the respective pre-determined period of time; and

applying the at least one identity group for managing information at the plurality of remote channels.

According to another embodiment of this aspect of the invention, the method provided further comprises a step of selecting at least one digital signage object from an identity group for which at least one of the attributes is to be modified, and creating a new identity group which comprises all members of the original identity group that should undergo such modification.

According to yet another embodiment the method provided further comprises a step of effecting a change at the identity group level, which change shall be carried out directly or indirectly on each of the digital signage objects belonging to said identity group.

By still another embodiment, the method provided further comprises a step by which an identity group is divided into two new identity groups upon applying at least one change to a new identity group, and wherein one of the newly formed identity groups comprises all members of the old identity group which are to be affected by the at least one change when applied, and the other newly formed identity group comprises all remaining members of the old identity group that would not be affected by that at least one change.

In accordance with yet another embodiment of this aspect of the invention, the method provided further comprises a step of merging two identity groups by applying attributes' values associated with one group of the digital signage objects to those of the other group.

### BRIEF DESCRIPTION OF THE DRAWINGS

FIGS. 1 to 4—illustrate steps in the process of using the identity group according to the present invention.

### DETAILED DESCRIPTION OF THE INVENTION

A better understanding of the present invention is obtained when the following non-limiting detailed description is considered in conjunction with the drawings.

In general, a digital Signage application comprises two major parts, a master (central) station(s) connected to a database and players. Typically, there are many players and few master stations. In order to manage multiple channels having a great diversity of attributes, the following is an example of implementing a solution in accordance with the present invention, in which the system is adapted to carry out certain functionalities as will be described hereinafter.

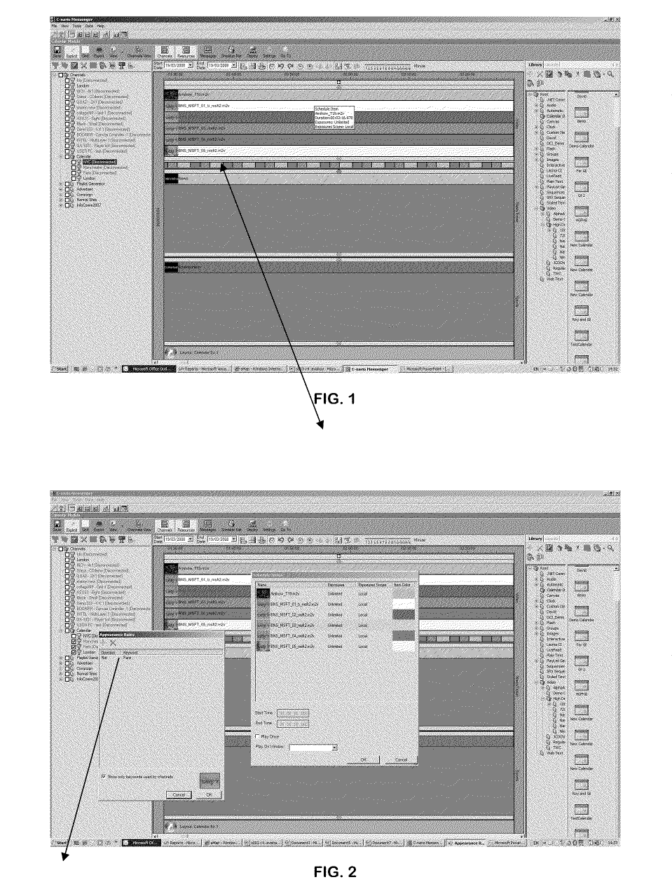

Let us consider an example where a smart schedule is created for a channel named NYC, the arrow in FIG. 1 points to an explicit graphical presentation of items to be placed on that date on the NYC channel starting at midnight. In order to force this calendar to behave differently on different channel, an ‘appearance rule’ is applied as demonstrated in FIG. 2.

By the appearance rule shown in FIG. 2 this item will not play on the channel named Paris (if it has been scheduled to play there), even though the same calendar object is associated with additional channels

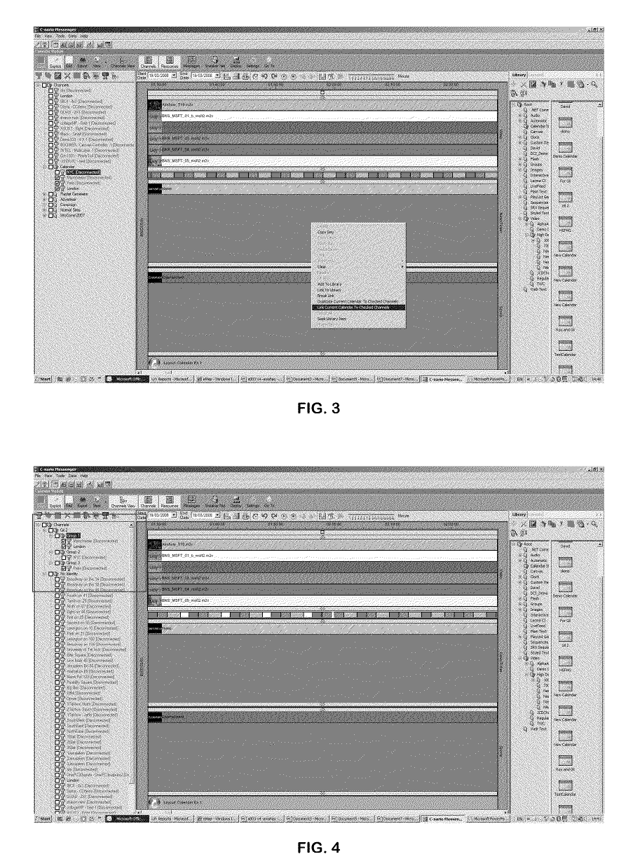

In FIG. 3 the channels demonstrated (Manchester, Paris and London) are now associated with the same calendar object that channel NYC is associated with.

FIG. 4 illustrates the use of the identity group according to the present invention view. From which it can be seen that the system has grouped Manchester and London together whereas Paris and NYC have separate groups.

In this particular workflow exemplified:
Application Module: Calendar Plug-in.
The pre-defined period of time: 18 Mar. 2008, for the duration of one day.
Digital Signage objects: Channels
Properties subset:
Linked Calendar objects (in this case Gi12), by this workflow, channels must be associated with the same calendar object in order to be considered as being of the same identity group.

If linked calendar is the same, the system checks for identical explicit playlist after having considered all appearance rules and basic scheduling for every item.

In this example a player or a single channel in a multi-channel player having multiple display surfaces shall be considered as the above referred to digital signage object (bearing in mind that a channel is typically connected to one display, and that the current example refers to the application of video walls in which a plurality of displays form a channel. Also, the properties' sub set of the present example is the playlist associated with a channel or with one of its display surfaces for an arbitrary period of time.
For a given set of channels, the system implicitly creates at the central station Identity Groups which allow common editing of the play list for the given period of time, where these groups are preferably presented in an hierarchical presentation (e.g. a tree configuration). In the present example, all constituent channels of an identity group have exactly the same playlist and the same rules creating the playlist (if it was created by rules) for the given period of the time (although as will be appreciated by those skilled in the art, an identity group of the present invention is not necessarily for the modification/creation of a playlist).
When an identity group is selected, changes to the set of properties/rules are applied to all identity group members (channels).
A partial list of identity group members may be selected. It may be carried out by selecting some of the nodes under the identity group branch, but it should be noted that a tree type of structure is not mandatory. Once changes are applied to such partial list, a new identity group may be created implicitly; the user interface may reflect these two identity groups, the newly created one along with the original identity group.
It is possible to merge two identity groups together by applying one group properties' sub set to the other group. This is effectively the opposite of the operation described previously. The user interface can be implemented by dragging one group branch on the other, and pasting the dragged on group properties' sub set into the dragged group ones.

There might be other options for the same operation.

As will be appreciated by those skilled in the art, the examples provided illustrate the use of plug-ins according to the present invention to allow display of information in digital signage systems. However, similar methods may be applied in a similar way in order to provide such plug-ins without departing from the scope of the present invention.

It is to be understood that the above description only includes some embodiments of the invention and serves for its illustration. Numerous other ways of carrying out the methods provided by the present invention may be devised by a person skilled in the art without departing from the scope of the invention, and are thus encompassed by the present invention.

1. A computer-readable medium comprising instructions that perform a method that when executed by a processor, is operative to establish a process for managing information during a pre-determined period of time at a plurality of remote display surfaces based on criteria established at a central terminal, wherein the method comprises:
providing a pre-determined period of time;
providing at least two digital signage objects;
determining at least one properties' sub set which comprises a plurality of attributes for each of the digital signage objects provided;
determining the value of attributes included in the at least one properties' sub set for the duration of the pre-determined period of time;
establishing at least one identity group comprising digital signage objects each of which is identical in its properties during a respective pre-determined period of time to the other digital signage objects belonging to a respective identity group; and
applying the at least one identity group for managing information at the plurality of remote channels.

2. A computer-readable medium according to claim 1, wherein the method provided further comprises a step of selecting at least one digital signage object from an identity group for which at least one of the attributes is to be modified, and creating a new identity group which comprises all members of the original identity group that should undergo such modification.

3. A computer-readable medium according to claim 1, wherein the method provided further comprises a step of effecting a change at the identity group level, which change shall be carried out directly or indirectly on each of the digital signage objects belonging to said identity group.

4. A computer-readable medium according to claim 1, wherein the method provided further comprises a step by which an identity group is divided into two new identity groups upon applying at least one change to a new identity group, and wherein one of the newly formed identity groups comprises all members of the old identity group which are to be affected by said at least one change when applied, and the other newly formed identity group comprises all remaining members of the old identity group that would not be affected by said at least one change.

5. A computer-readable medium according to claim 1, wherein the method provided further comprises a step of merging two identity groups by applying attributes' values associated with one group of the digital signage objects to those of the other group.

6. A method for managing information during a pre-determined period of time at a plurality of remote display surfaces, based on criteria established at a central terminal, wherein said method comprises:
providing a pre-determined period of time;
providing at least two digital signage objects;
determining at least one properties' sub set which comprises a plurality of attributes for each of the digital signage objects provided;
determining the value of attributes included in the at least one properties' sub set for the duration of the pre-determined period of time;
establishing at least one identity group comprising digital signage objects each of which is identical in its properties during a respective pre-determined period of time to the other digital signage objects belonging to a respective identity group; and
applying the at least one identity group for managing information at the plurality of remote channels.

7. A method according to claim 6, further comprising a step of selecting at least one digital signage object from an identity group for which at least one of the attributes is to be modified, and creating a new identity group which comprises all members of the original identity group that should undergo such modification.

8. A method according to claim 6, further comprising a step of effecting a change at the identity group level, which change shall be carried out directly or indirectly on each of the digital signage objects belonging to said identity group.

9. A method according to claim 6, further comprising a step by which an identity group is divided into two new identity groups upon applying at least one change to a new identity group, and wherein one of the newly formed identity groups comprises all members of the old identity group which are to be affected by said at least one change when applied, and the other newly formed identity group comprises all remaining members of the old identity group that would not be affected by said at least one change.

10. A method according to claim 6, further comprising a step of merging two identity groups by applying attributes' values associated with one group of the digital signage objects to those of the other group.
